(19) United States
(12) Patent Application Publication
(10) Pub. No.: US 2010/0315343 A1
(43) Pub. Date: Dec. 16, 2010

(54) KEYBOARD

(75) Inventor: CHOON-TYNG LAU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/558,321

(22) Filed: Sep. 11, 2009

(30) Foreign Application Priority Data
Jun. 15, 2009 (CN) 200910303258.8

(51) Int. Cl. G06F 3/02

(52) U.S. Cl. 345/168

(57) ABSTRACT

A keyboard includes a base and a cover. The base receives a main circuit board therein, and the cover receives a flexible circuit board therein. The flexible circuit board is electrically coupled to the main circuit board and comprises of a plurality of touch areas located thereon. Each touch area is capable of generating electrical signals in the flexible circuit board when touched. The electrical signals are capable of being transmitted to the main circuit board. A plurality of key areas is integrated on the cover respectively corresponding to the touch areas. Each of the key areas is resiliently deformable and capable of touching the corresponding touch area.

### BACKGROUND

1. Technical Field

The present disclosure relates to keyboards, and particularly to a thin keyboard.

2. Description of Related Art

Conventionally, a plurality of keys are located on a keyboard. Each of the keys usually includes a keycap and a spring mechanism for moving the keycap to a normal state after the keycap is pressed and released. The spring mechanism may be, for example, a resilient dome or levers. Therefore, the conventional keyboard is relatively tall, and cannot satisfy requirement of some electronic devices, such as notebook computers, mobile telephones and so on.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is n exploded, isometric view of keyboard, in accordance with an embodiment.

FIG. 2 is an assembled view of FIG. 1.

FIG. 3 is a cutaway view of the keyboard of FIG. 2.

### DETAILED DESCRIPTION

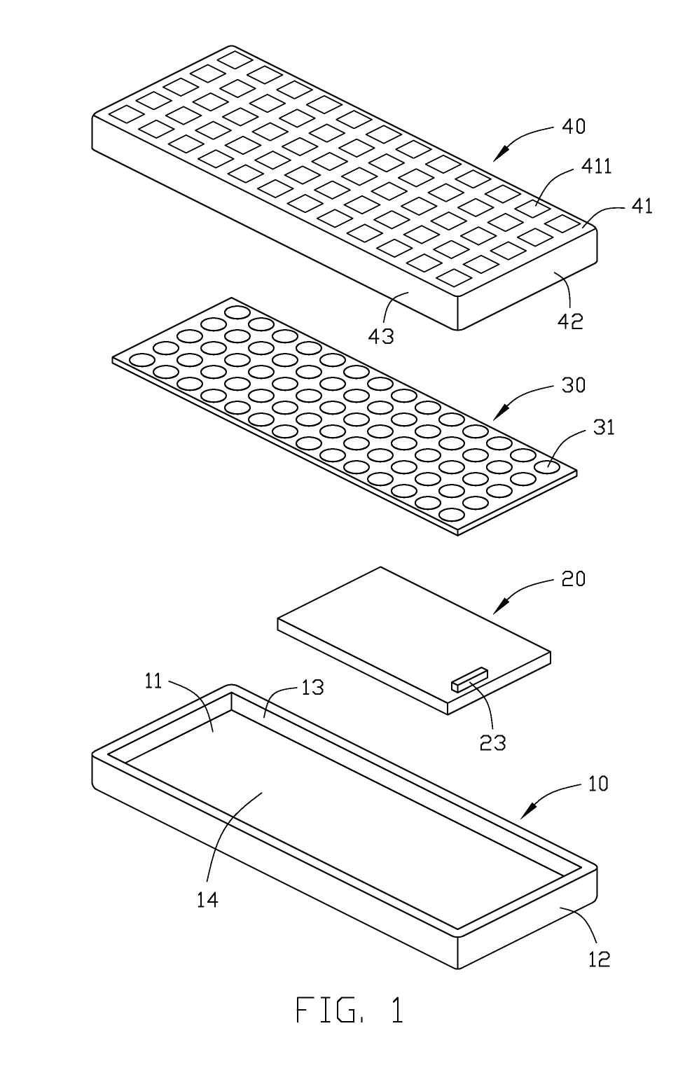

Referring to FIG. 1, a keyboard in accordance with an embodiment includes a base 10, a flexible circuit board 20, a main circuit board 30, and a cover 40. The flexible circuit board 20 and the main circuit board 30 are located between the base 10 and the cover 40.

The base 10 includes a bottom plate 11, two parallel first side plates 12 perpendicular to the bottom plate 11, and two parallel second side plates 13 perpendicular to the bottom plate 11 and the side plates 12. A first holding space 14 is defined by the bottom plate 11, the first side plates 12, and the second side plates 13.

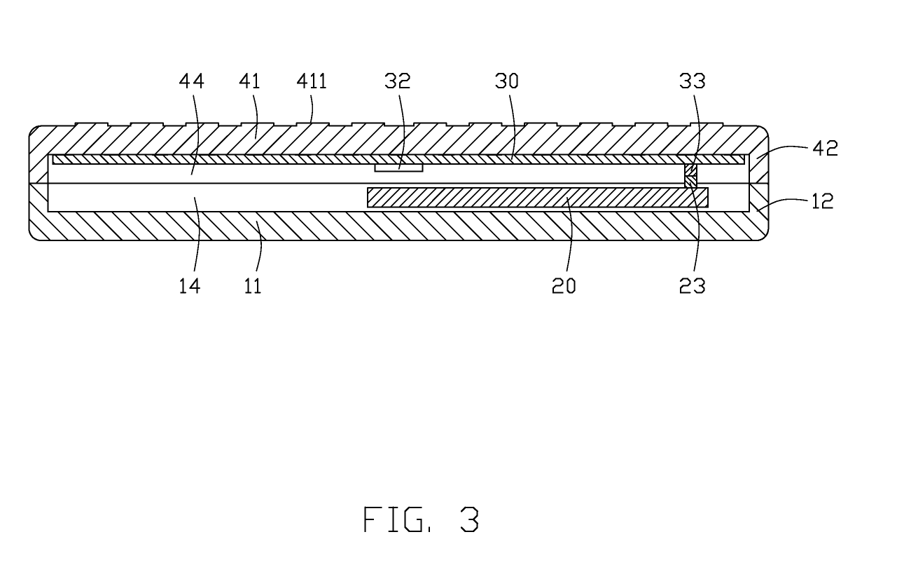

The main circuit board 20 is configured to be secured in the first holding space 14. A first connector 23 is located on the circuit board 20. A plurality of touch areas 31 is formed on the flexible circuit board 30, and the touch areas 31 are capable of producing electrical signals when touched. A chip 32 and a second connector 33 (shown in FIG. 3) are located on the flexible circuit board 30. Each of the touch areas 31 is electrically coupled to the chip 32 via traces. The second connector 33 is configured to electrically couple to the first connector 23.

The cover 40 includes a top wall 41, two parallel first sidewalls 42 perpendicular to the top wall 41, and two parallel second sidewalls 43. A second holding space 44 (shown in FIG. 3) is defined by the top wall 41, the first sidewalls 42, and the second sidewalls 43. The second holding space 44 is configured to receive the flexible circuit board 30. A plurality of key areas 411 is integrated on the top wall 41, and each key area 411 is configured to align with a corresponding touch area 31 of the flexible circuit board 30. The top wall 41 has such a thickness that each of the key areas is configured to be resiliently deformed to touch the corresponding touch area 31 when pressed, without adjacent key areas 411 responding to the press and touching corresponding touch areas 31.

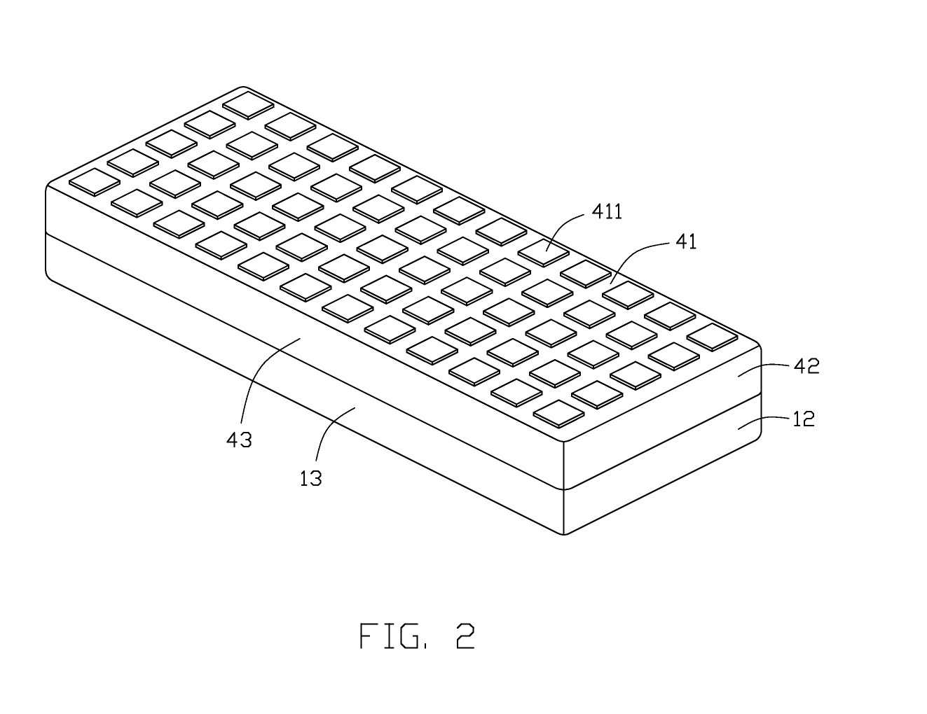

Referring also to FIGS. 2-3, in assembly, the main circuit board 20 is secured in the first holding space 14 of the base 10 with fasteners (not shown). The flexible circuit board 30 is secured in the second holding space 44 of the cover 40 with fasteners (not shown), and each key area 411 aligns with each corresponding touch area 31. The cover 40 with the flexible circuit board 30 is secured on the base 10 with the main circuit board 20 with fasteners (not shown), and the second connector 33 is electrically coupled to the first connector 23.

In use, when one of the key areas 411 is pressed, the one key area 411 is resiliently deformed to touch one corresponding touch area 31. The one touch area 31 generates an electrical signal in the chip 32 of the flexible circuit board 30, and the electrical signal is transmitted to the main circuit board 20 via the second connector 33 and the first connector 23.

In one embodiment, because the key areas 411 are integrated with the cover 40, the thicknesses of the key areas 411 is determined by the thickness of the top wall 41 of the cover 40 and therefore are thinner than conventional keyboard keys. Therefore, the keyboard of the present embodiment can be thinner than a conventional keyboard by using the present key areas 41.

In addition, the key areas 411 can be formed on the cover 40 by printing, spray painting, laser or other means. The thickness of the top wall 41 of the cover 40 may be 3 mm or less if needed.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A keyboard comprising:
a base receiving a main circuit board therein; and
a cover receiving a flexible circuit board therein; the flexible circuit board being electrically coupled to the main circuit board and comprising of a plurality of touch areas located thereon; wherein each touch area is capable of generating electrical signals in the flexible circuit board when touched; the electrical signals are capable of being transmitted to the main circuit board;
a plurality of key areas integrated on the cover respectively corresponding to the touch areas; wherein each key area is resiliently deformable and capable of touching the corresponding touch area.

2. The keyboard of claim 1, wherein the base defines a first holding space for receiving the main circuit board.

3. The keyboard of claim 1, wherein the cover defines a second holding space for receiving the flexible circuit board.

4. The keyboard of claim 1, wherein a first connector is located on the main circuit board; a second connector is located on the flexible circuit board, and connected to the first connector.

5. The keyboard of claim 1, wherein the cover comprises a top wall; the key areas are integrated on the top wall.

6. The keyboard of claim 1, wherein the thickness of the top wall is less than or equal to 3 mm.

7. The keyboard of claim 1, wherein a chip is formed on the flexible circuit board; and the electrical signal is generated through the chip when one of the touch areas is touched.

8. A keyboard comprising:
a base receiving a main circuit board therein; and
a cover receiving a flexible circuit board therein; wherein the flexible circuit board is electrically coupled to the main circuit board and comprises of a chip and a plurality of touch areas located thereon; the chip generates electrical signals when the touch areas are touched, and transmits the electrical signals to the main circuit board; the cover comprises a top wall capable of being touched corresponding to the touch areas to cause the chip to generate the electrical signals.

9. The keyboard of claim 8, wherein the base defines a first holding space for receiving the main circuit board.

10. The keyboard of claim 8, wherein the cover defines a second holding space for receiving the flexible circuit board.

11. The keyboard of claim 8, wherein a first connector is located on the main circuit board; a second connector is located on the flexible circuit board, and connected to the first connector.

12. The keyboard of claim 8, wherein a key area is integrated on the top wall position by printing or laser or spray painting.

13. The keyboard of claim 8, wherein the thickness of the top wall is less than or equal to 3 mm.
